(19) United States
(12) Patent Application Publication
(10) Pub. No.: US 2008/0007419 A1
(43) Pub. Date: Jan. 10, 2008

(54) Light driving device

(75) Inventors: Jung-Yuan Tsai, Taoyuan (TW); Kuo-Feng Chen, Taoyuan (TW); Ching-Hao Tseng, Taoyuan (TW)

Correspondence Address: BIRCH STEWART KOLASCH & BIRCH, PO BOX 747, FALLS CHURCH, VA, 22040-0747, US

(73) Assignee: HIGH TECH COMPUTER, CORP.

(21) Appl. No.: 11/808,393

(22) Filed: Jun. 8, 2007

(30) Foreign Application Priority Data
Jun. 9, 2006 (TW) 95120599

(51) Int. Cl. G09F 9/33

(52) U.S. Cl. 340/815.45

(57) ABSTRACT

A light driving device comprises a signal generator, a demultiplexer and a light driving circuit. The signal generator generates a signal. The demultiplexer converts the signal to at least a control signal. The light driving circuit is controlled by the control signal.

### BACKGROUND OF THE INVENTION

1. Field of the Invention

The invention relates to a light driving device and, in particular, to a light driving device and a light driving method for alternately driving lights with a single signal.

2. Description of the Related Art

In various electronic devices, lights are often used to indicate different states thereof. Different light signals are required according to different applications of the electronic devices. As a result, light driving devices are required to control flashing, i.e. ON and OFF states, of the lights.

There are two methods generally used to drive lights. The first one, as shown in FIG. 1, is that control signals of light emitting diodes (LEDs) are provided by a general purpose input/output (GPIO) of a central processing unit (CPU), and duty cycles and periods of the control signals are determined by programs and counters inside the CPU.

The second one, as shown in FIG. 2, is that an LPG controller for providing control signals of LEDs is built into a CPU, in which there are some adjustable parameters such as ON/OFF, frequency, duty cycle, etc., and durations and periods of the control signals are determined by counters in an integrated circuit (IC). Typically, two LPG controllers are alternately activated to generate two alternating control signals for driving two LEDs. However, the method for driving two LEDs has two disadvantages: (1) one more LPG controller is required and thus increases circuit complexity; and (2) time intervals between the two alternating control signals are determined by respective activation timing of the LPG controllers and thus cannot be controlled precisely.

### BRIEF SUMMARY OF THE INVENTION

One embodiment of the present invention provides a light driving device, which comprises a signal generator, a demultiplexer and a first light driving circuit and a second light driving circuit. The signal generator generates a signal. The demultiplexer converts the signal to a first control signal and a second control signal. The first and second light driving circuits are respectively controlled by the first and second control signals.

Another embodiment of the present invention provides a light driving device, which comprises a signal generator, a demultiplexer and a first light driving circuit and a second light driving circuit. The signal generator generates a signal. The demultiplexer comprises a D flip-flop for converting the signal to a first control signal and a second control signal. The first and second light driving circuits are respectively controlled by the first and second control signals.

Another embodiment of the present invention provides a light driving method, which comprises generating a signal, converting the signal to a first control signal and a second control signal, and controlling two lights according to the first control signal and the second control signal.

Compared with a traditional light driving device in which one LPG pin only controls one light emitting diode, the light driving device according to the present invention controls more than one light emitting diode with one LPG pin such that LPG pins can be saved. In addition, flashing duty cycles of the light emitting diodes can be controlled by setting the period and duty cycle of one LPG signal in software associated with the light driving device.

A detailed description is given in the following embodiments with reference to the accompanying drawings.

### BRIEF DESCRIPTION OF THE DRAWINGS The invention can be more fully understood by reading the subsequent detailed description and examples with references made to the accompanying drawings, wherein:

FIG. 1 is a circuit diagram of a conventional light driving device;

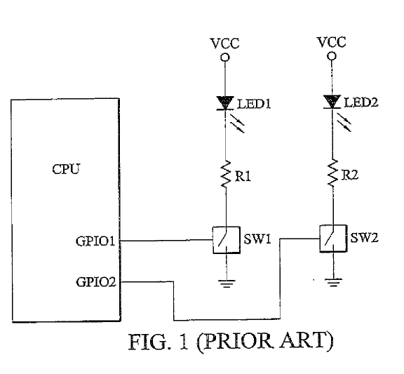

FIG. 2 is a circuit diagram of a conventional light driving device;

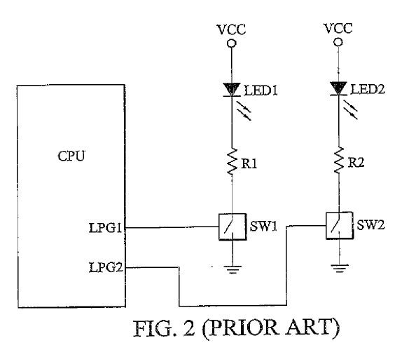

FIG. 3 is a block diagram of a light driving device according to one embodiment of the invention;

FIG. 4 is a circuit diagram of the light driving device 300 shown in FIG. 3;

FIG. 5 is a timing diagram of signals for operation of the light driving device 300 shown in FIG. 4; and

FIG. 6 is a flow chart of a light driving method for driving lights according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

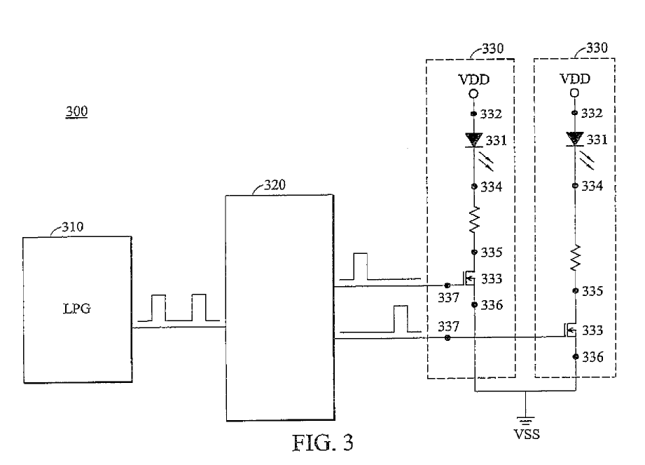

FIG. 3 is a block diagram of a light driving device according to one embodiment of the invention. The light driving device 300 comprises a signal generator 310, a demultiplexer 320 and at least one light driving circuit 330. The signal generator 310 generates a signal. The demultiplexer 320 converts the signal to at least one control signal. The light driving circuits 330 are controlled by the control signals. Preferably, the signal generator 310 is an LED pulse generator (LPG) which generates an LPG signal. Each light driving circuit 330 comprises a light emitting diode 331 and a switch 333. Preferably, the switch 333 is a MOS transistor. The light emitting diode 331 has a first terminal 332 connected to a first voltage V_{DD}. The switch 333 has a first terminal (drain) 335 coupled to a second terminal 334 of the light emitting diode 331, a second terminal (source) 336 coupled to a second voltage V_{SS}, and a third terminal (gate) 337 coupled to the demultiplexer 320 for receiving the control signal. Preferably, the first voltage V_{DD} and the second voltage V_{SS} are respectively a power supply voltage and a ground.

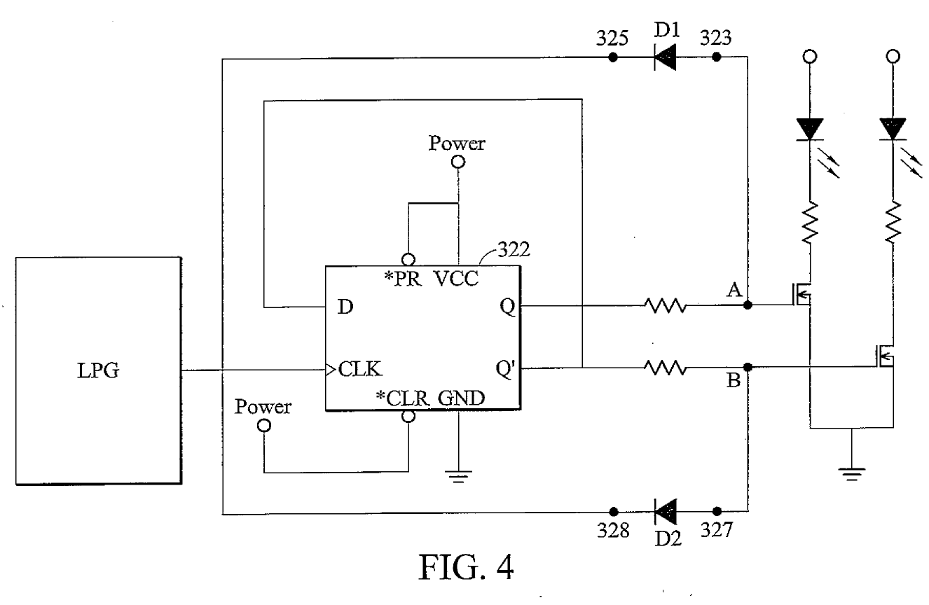

FIG. 4 is a circuit diagram of the light driving device 300 shown in FIG. 3. More specifically, the demultiplexer 320 comprises a D flip-flop 322, a first diode D1 and a second diode D2. The D flip-flop 322 has a data input terminal D, a clock terminal CLK, an output terminal Q and an inverting output terminal Q′. The clock terminal CLK receives the signal. The inverting output terminal Q′ outputs an output signal fed back to the data input terminal D. The output terminal and the inverting output terminal Q′ respectively control the light driving circuits 330. The first diode D1 has an anode 323 coupled to the output terminal Q and a cathode 325 coupled to the clock terminal CLK. The second diode D2 has an anode 327 coupled to the inverting output terminal Q′ and a cathode 328 coupled to the clock terminal CLK.

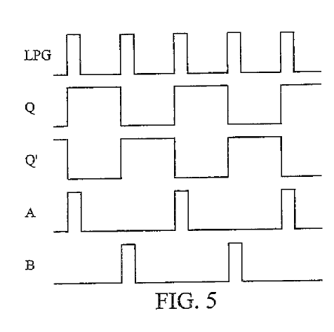

FIG. 5 is a timing diagram of signals for the operation of the light driving device 300 shown in FIG. 4. LPG represents a signal generated by the signal generator 310. Q and Q′ respectively represent output signals of the output terminal Q and the inverting output terminal Q′. A and B respectively represent voltage levels of the nodes A and B shown in FIG. 4. When signals Q and Q′ respectively start in low and high levels, operation of the light driving device 300 can be divided into four stages. In the first stage, when the signal LPG transits from low level to high level, the logic state of the signal Q′ is then latched via the data input terminal D. As a result, the signal Q transits from low level to high level and the signal Q′ transits from high level to low level. Thus, the first and second diodes D1, D2 are reverse-biased and the nodes A and B are respectively at high and low levels. In the second stage, when the signal LPG transits from high level to low level, the first diode D1 is forward biased such that the node A is pulled to low level and the node B stays in low level. In the third stage, when the signal LPG transits again from low level to high level, the logic state of the signal Q′ is then latched via the data input terminal D. As a result, the signal Q transits from high level to low level and the signal Q′ transits from low level to high level. Thus, the first diode D1 and the second diode D2 are reverse biased such that the node A stays in low level and the node B transits from low level to high level. In the fourth stage, when the signal LPG transits from high level to low level, the second diode D2 is forward biased such that the node B is pulled to low level and the node A still stays in low level. As a result, the four stages repeat again and again and the light emitting diodes 331 are alternately turned ON/OFF with a period twice of that of the LPG signal.

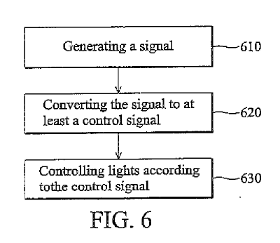

The present invention also provides a light driving method for driving lights. As shown in FIG. 6, the method comprises generating a signal (610), converting the generated signal to a first control signal and a second control signal (620), and controlling two lights according to the first control signal and the second control signal (630). More specifically, the generated signal is an LPG signal and the lights are light emitting diodes.

Compared with a traditional light driving device in which one LPG pin only controls one light emitting diode, the light driving device according to the present invention controls more than one light emitting diode with one LPG pin such that LPG pins can be saved. In addition, flashing duty cycles of the light emitting diodes can be controlled by setting the period and duty cycle of one LPG signal in software associated with the light driving device.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A light driving device, comprising:
a signal generator for generating a signal;
a demultiplexer for converting the generated signal to a first control signal and a second control signal;
a first light driving circuit controlled by the first control signal; and
a second light driving circuit controlled by the second control signal.

2. The light driving device as claimed in claim 1, wherein the signal generator is an LED pulse generator.

3. The light driving device as claimed in claim 1, wherein each of the first and second light driving circuits comprises:
a light having a first terminal connected to a first voltage, and a second terminal, and
a switch having a first terminal coupled to the second terminal of the light, a second terminal connected to a second voltage, and a third terminal coupled to the demultiplexer,
wherein the third terminal of the switch of the first light driving circuit receives the first control signal, and the third terminal of the switch of the second light driving circuit receives the second control signal.

4. The light driving device as claimed in claim 3, wherein the light is a light emitting diode and the switch is a MOS transistor, and wherein the first terminal is a drain, the second terminal is a source, and the third terminal is a gate.

5. The light driving device as claimed in claim 4, wherein the first and second voltages are respectively a power supply voltage and a ground.

6. The light driving device as claimed in claim 1, wherein the demultiplexer comprises a D flip-flop having a data input terminal, a clock terminal for receiving the generated signal, an output terminal for outputting the first control signal, and an inverting output terminal for outputting the second control signal, wherein the second output signal is fed back to the data input terminal, and the first light driving circuit and the second light driving circuit are respectively controlled by the first control signal and the second control signal.

7. The light driving device as claimed in claim 6, wherein the demultiplexer comprises a first diode having an anode coupled to the output terminal and a cathode coupled to the clock terminal, and a second diode having an anode coupled to the inverting output terminal and a cathode coupled to the clock terminal.

8. A light driving device, comprising:
a signal generator for generating a signal;
a demultiplexer comprising a D flip-flop for converting the generated signal to a first control signal and a second control signal;
a first light driving circuit controlled by the first control signal; and
a second light driving circuit controlled by the second control signal.

9. The light driving device as claimed in claim 8, wherein the signal generator is an LED pulse generator.

10. The light driving device as claimed in claim 8, wherein each of the first and second light driving circuits comprises:
a light having a first terminal connected to a first voltage, and a second terminal, and
a switch having a first terminal coupled to the second terminal of the light, a second terminal connected to a second voltage, and a third terminal coupled to the demultiplexer,
wherein the third terminal of the switch of the first light driving circuit receives the first control signal, and the third terminal of the switch of the second light driving circuit receives the second control signal.

11. The light driving device as claimed in claim 10, wherein the light is a light emitting diode and the switch is a MOS transistor, and wherein the first terminal is a drain, the second terminal a source, and third terminal a gate.

12. The light driving device as claimed in claim 11, wherein the first and second fixed voltages are respectively a power supply voltage and a ground.

13. The light driving device as claimed in claim 8, wherein the D flip-flop has a data input terminal, a clock terminal for receiving the generated signal, an output terminal for outputting the first control signal, and an inverting output terminal for outputting the second control signal, wherein the second output signal is fed back to the data input terminal, and the first light driving circuit and the second light driving circuits are respectively controlled by the first control signal and the second control signal.

14. The light driving device as claimed in claim 13, wherein the demultiplexer comprises a first diode having an anode coupled to the output terminal and a cathode coupled to the clock terminal, and a second diode having an anode coupled to the inverting output terminal and a cathode coupled to the clock terminal.

15. A light driving method for driving lights, comprising:
generating a signal;
converting the generated signal to a first control signal and a second control signal; and
controlling two lights according to the first control signal and the second control signal.

16. The light driving method as claimed in claim 15, wherein the generated signal is an LPG signal.

17. The light driving method as claimed in claim 15, wherein the lights are light emitting diodes.
